(19) United States
(12) Patent Application Publication
(10) Pub. No.: US 2009/0159382 A1
(43) Pub. Date: Jun. 25, 2009

(54) Rotary damper

(76) Inventors: Louis Chemouni, Burbank, CA (US); Gerald Lo, Burbank, CA (US); Hanh Dong, Pomona, CA (US)

Correspondence Address: CLARK & BRODY, 1090 VERMONT AVENUE, NW, SUITE 250, WASHINGTON, DC, 20005, US

(21) Appl. No.: 12/003,388

(22) Filed: Dec. 21, 2007

(51) Int. Cl. F16F 9/14

(52) U.S. Cl. 188/290

(57) ABSTRACT

A rotary viscous damper, comprising a stator and a rotor defining between them a main chamber filled with a visco-elastic fluid, which can be of a thixotropic, dilatant, or Bingham, etc, or Magneto-Rheological nature, substantially radial paddles being disposed on each of said stator and rotor, said paddles dividing said main chamber into a plurality of chambers, and presenting means to create a fluid communication between the chambers through specifically shaped conduits that may be located at either the exterior, interior, upper or lower section of the damping chambers. Said damper further comprises at least one conical elastomeric bearing between the stator and the rotor to serve as dynamic sealing, as well as a guide between the stator and the rotor. A volume compensation device is also comprised in the said damper to accommodate fluid temperature changes. Self-lubricated bearings are also comprised in the said damper to guide the main shaft of the stator. Such bearings can be replaced with metal-bearings as the envelope permits. The stator paddles may each have two pressure-relief valves installed, one for each of tandem damping chambers, to limit the load born by the rotary damper structure. Said damper's rotor is also specially coated on the interior to minimize wearing and augment the life of the part. Said damper's housing exterior has heat-dissipative fins to cool the damper especially during extended periods of operation as fluid temperature increases. In low temperature environments, said damper operates with heating elements installed at the exterior or interior of the damping chamber to pre-heat the fluid, reducing start-up time for said damper on a helicopter. Said damper also comprised of a pressure-monitoring system to monitor damping characteristics of the damping throughout the life of the damper as a pre-emptive effort against failure of the damper out in the field.

### FIELD OF THE INVENTION

This invention relates to a rotary damper for installation between a fixed part and a mobile part of a mechanism.

### BACKGROUND OF THE INVENTION

Rotary dampers have been used in a variety of applications, for instance industrial vehicles, railway and motorcycles. Known dampers comprise a stator and a rotor defining between them a main chamber filled with fluid, particularly a viscous fluid such as silicone oil. At least two paddles or the like are disposed substantially radially on the rotor, to divide the main chambers into at least two chambers, as described in U.S. Pat. No. 7,048,098.

U.S. Pat. No. 6,840,356, U.S. Pat. No. 6,899,208 or U.S. Pat. No. 4,768,630 describes a damper with a stator and a rotor, each comprising a plurality of radial paddles. U.S. Pat. No. 4,768,630 illustrates a damper in which the main chamber is divided into eight chambers, filled with fluid.

Means are provided to create a communication between the chambers to enable the transfer of fluid from one chamber to another when a relative rotational movement occurs between the rotor and the stator.

These means are for instance orifices or valves in the paddles and/or passages between the end of each paddles of the stator and the internal wall of the rotor or any other passages that allow fluid communication between said chambers. The fluid flow through this orifice, passage or conduit induced by the relative rotational motion of the stator vs. the rotor provides the expected damping.

A damper can be provided between the main rotor hub of a helicopter and each of its blades. The main rotor hub provides rotational momentum to the blades in order to create aerodynamic lift. The main rotor hub must allow for rotational motion of the blades in the vertical (flap), horizontal (lead-lag), and axial (pitch) directions near the blade root attachment with the hub to accommodate flight control and dynamic stability regulation. Main rotor hub systems that accommodate these motions with discrete hinge mechanisms are referred to as fully articulated hubs. Throughout the improvements of the helicopter, it has been tried to provide rotational freedom with bearing systems that can accommodate high loading and high amplitude oscillatory motion under high thrust loading created by the centrifugal force of the rotating blades.

Known linear lead-lag dampers have utility in a helicopter main rotor assembly for damping lead-lag motions induced in the main or tail rotor blades.

These devices provide the necessary damping to limit the lead-lag blade motion particularly when the rotor-head is started or stopped to avoid the potentially detrimental ground resonance effect.

Known helicopter lead-lag dampers utilized in production units to date are solely linear dampers using either friction or high damping visco-elastic, fluid or elasto-hydraulic technologies. Visco-elastic dampers have design and characteristics limitation and are mainly used for small to medium size helicopters.

Linear fluid dampers are rather used for medium to heavy helicopters. The main drawback of this type of lead-lag dampers is their low “mean-time-between-failure” (MTBF) due mainly to leakage at the dynamic seal level. Some linear dampers also require additional fittings for fluid communication between the chambers and an accumulator. Such fittings are external to the damper and pose additional risks for leakage.

Up to now, there is no application of rotary dampers to helicopter rotor head in production. Indeed, designing a rotary damper onto the helicopter faces several challenges such as: high vibratory environment, large operating temperature range (typically −65° F. to +140° F.), required characteristics stability vs. time and making the rotary damper compact and light, both of which are particularly important in the aerospace industry. They are also complex to produce since several means must be provided to make the damper leak-tight.

Moreover, during the repeated functioning of these dampers, the total volume of the viscous fluid varies as a function of the temperature. When this rises, the fluid expands and occupies a greater volume. On the contrary, when the temperature goes down, the fluid becomes more compact and occupies a smaller volume.

In this case, there is a risk that the internal chamber of these dampers is not filled with an optimum quantity of fluid, which will cause loss of damping characteristics, due notably to the phenomenon of cavitation inside the chamber. In an attempt to overcome this drawback, a rotary damper has been proposed, for example in U.S. Pat. No. 4,768,630.

This damper comprises two auxiliary chambers which are defined between the main chamber of the damper and two opposite diaphragms and which are in communication with the main chamber by a functional clearance. With these auxiliary chambers, it is possible to compensate for the variations in volume of the viscous fluid as a function of its operating temperature.

Such a damper is complex and expensive to produce, since it needs two volume compensation devices and suitable means to seal the auxiliary chambers.

The object of the present invention is to provide a rotary viscous damper that is relatively uncomplicated mechanically, that maintains axially and radially the rotor part of the damper during the life time of the damper, to eliminate any cocking motion and that limits the number of seals required to reduce the possibility of leakage over many hours of operation, thereby extending the lifespan of the components.

This object is achieved for a rotary viscous damper comprising a stator and a rotor defining between them a main chamber filled with a fluid, substantially radial paddles being disposed on each of said stator and rotor, said paddles dividing said main chamber into a plurality of chambers, and presenting means to create a fluid communication between the chambers, said damper further comprising at least one conical elastomeric bearing between the stator and the rotor.

The use of conical elastomeric bearing provides dynamic sealing, eliminating the presence of abrading sealing surfaces, which is a contributing factor to low MTBF and enables the damper to withstand the high dynamic pressure with a very low volume variation divided by pressure ratio.

The laminated elastomeric bearings have not only a dynamic sealing function but also a guidance function of the main shaft-stator assembly in relation to the rotor-housing assembly.

In a specific embodiment, it is provided another bearing between the stator and the rotor, to improve the guidance between the stator versus the rotor. Such is the case where a tighter tolerance guidance is necessary to achieve higher damping and less wearing. This bearing is a self-lubricated bearing or equivalent.

Additional features of the said invention are as follows:
the said at least one conical elastomeric bearing comprises a metal-elastomer laminated material; which can consist of multiple layers of elastomers with metallic shims in between every layer.
in a first variant, the said layers are conically converging to the center of the damper.
in a second variant, the said layers are conically diverging to the center of the damper.
the damper further comprises a volume compensation device;
the volume compensation device comprises an auxiliary chamber which communicates with said main chamber, said auxiliary chamber being defined between a substantially transverse wall of the rotor and a sealing diaphragm, which is elastically urged against the said wall;
the diaphragm is provided on a piston which is loaded by springs, in order to be axially movable in function of the temperature of the fluid in the main chamber;
at least one conduit is provided, with opened ends in fluid communication with entry holes of the stator, to create a fluid communication between two associated chambers;
in a first variant, the rotor presents a central bore in which is mounted a shaft, the said at least one conduit being provided on the external wall of said shaft.
in a second variant, the said at least one conduit is provided on the external wall of the main chamber.
in a third variant, the said at least one conduit is provided on the top, on the bottom or on the top and bottom of the main chamber.
The length, cross-section and profile of said at least one conduit are determined to provide the required damping characteristics.
the damper includes relief values for torque limitation purposes; the relief valves being provided by pairs at each of their location.
an anti-wear coating is provided on dynamic surfaces subject to abrasion.
an autonomous pressure monitoring system is provided to make maintenance easier.
cooling fins are provided on the exterior of damper housing to dissipate energy generated by the damper when it operates.
a heating element is provided inside or outside the damper housing to raise fluid temperature prior to damper operation or in low temperature environments, so that required damping characteristics are achieved immediately.

Additional features and advantages of the present invention will become apparent from the subsequent description, taken in conjunction with the accompanying drawings, which show:

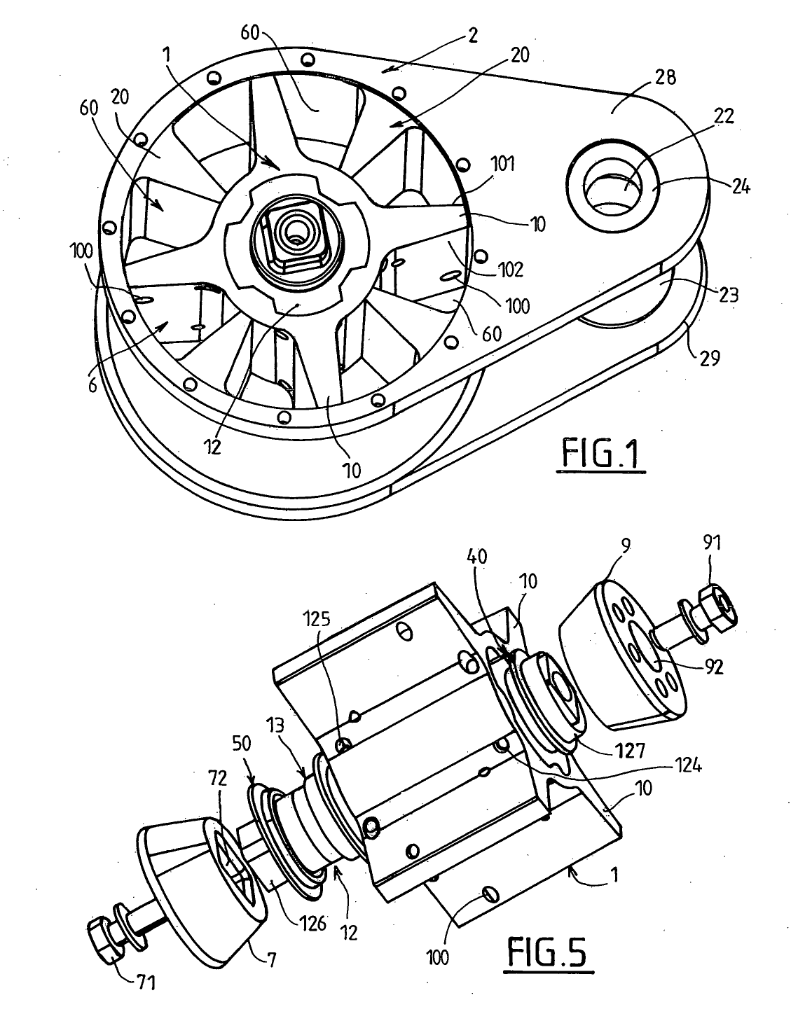

FIG. 1, a schematic perspective view of a rotary damper device in accordance with the present invention;

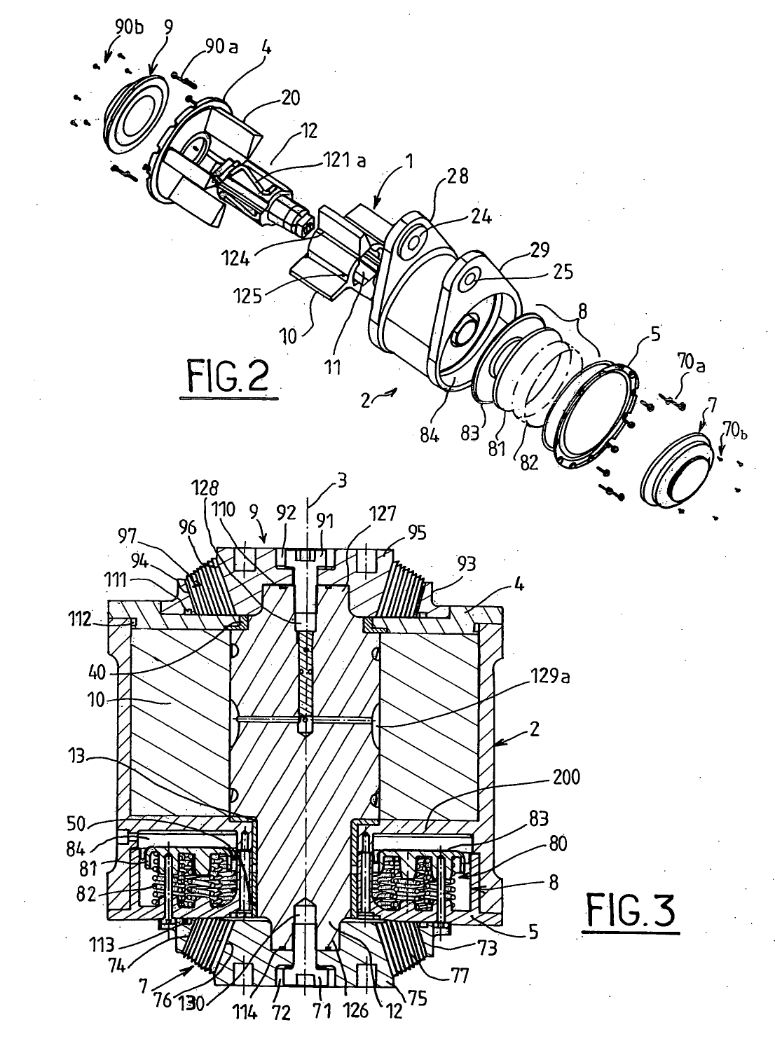

FIG. 2, an exploded perspective view of a damper device according to FIG. 1;

FIG. 3, an axial cross-section of the damper device according to FIGS. 1 and 2;

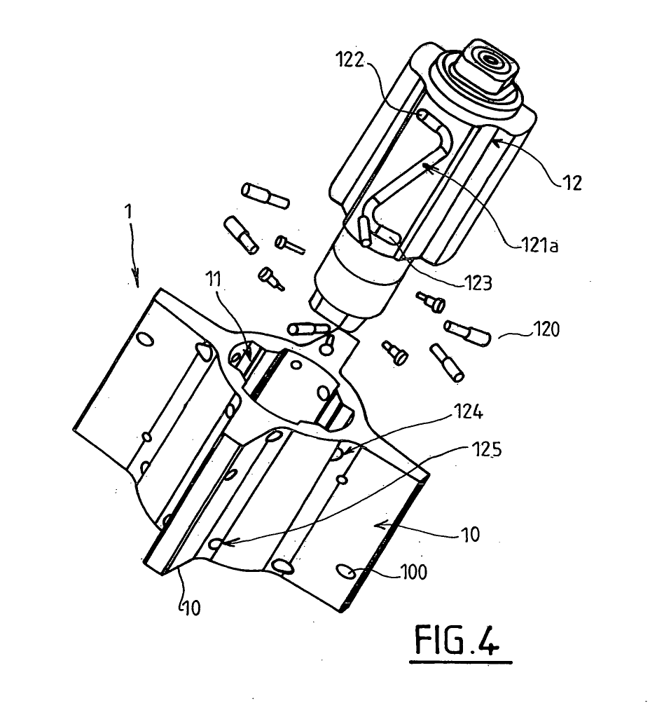

FIG. 4, a partial enlarged view of FIG. 2;

FIG. 5, another partial enlarged view of FIG. 2;

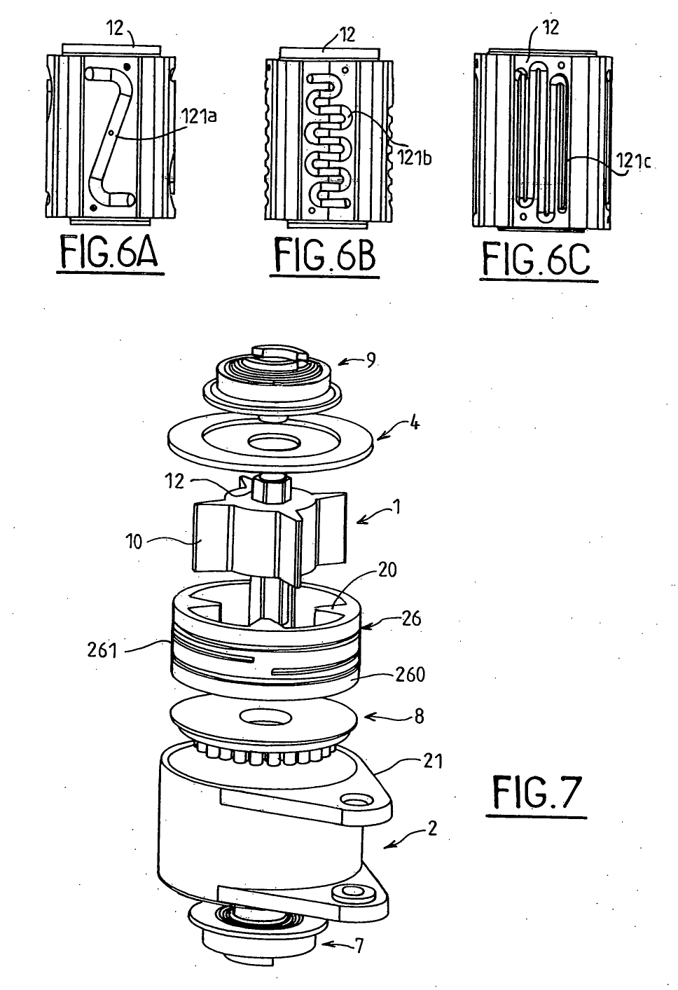

FIG. 6, which includes FIGS. 6A, 6B and 6C showing various shapes of conduits located on the damper shaft;

FIG. 7, exploded perspective view of a damping device according to the invention, showing a conduit on the outside diameter of a damping chamber;

FIG. 8, an axial cross-section of the damping device illustrated in FIG. 7;

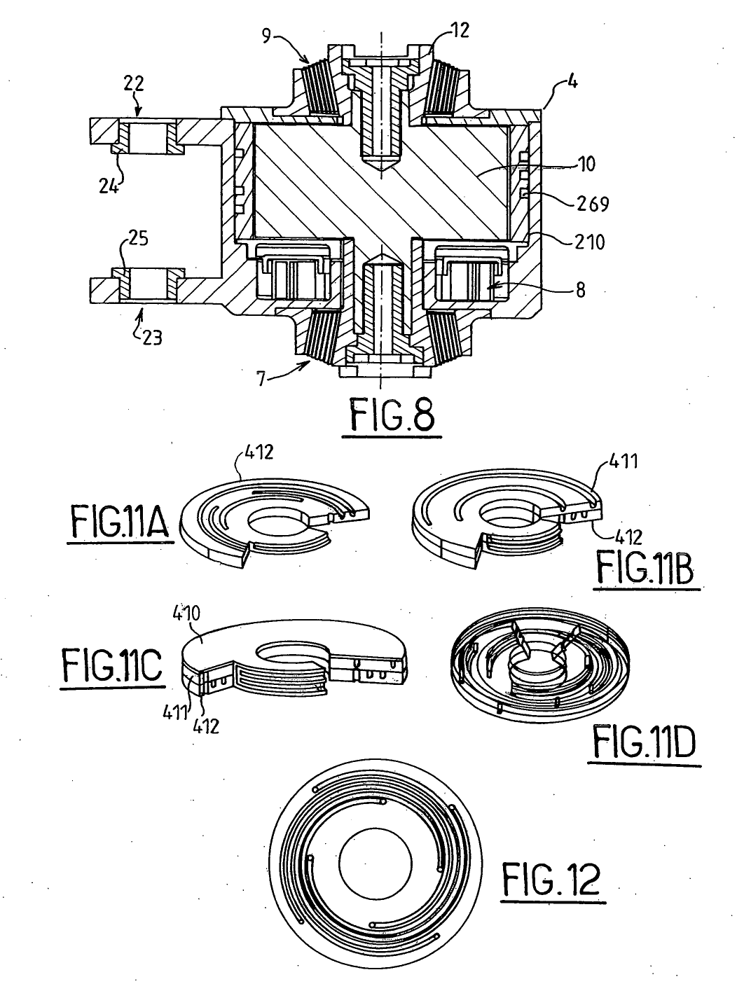

FIG. 9, exploded perspective view of a damping device according to the invention, showing a conduit on the top cover of a damper, arranged as a double-deck.

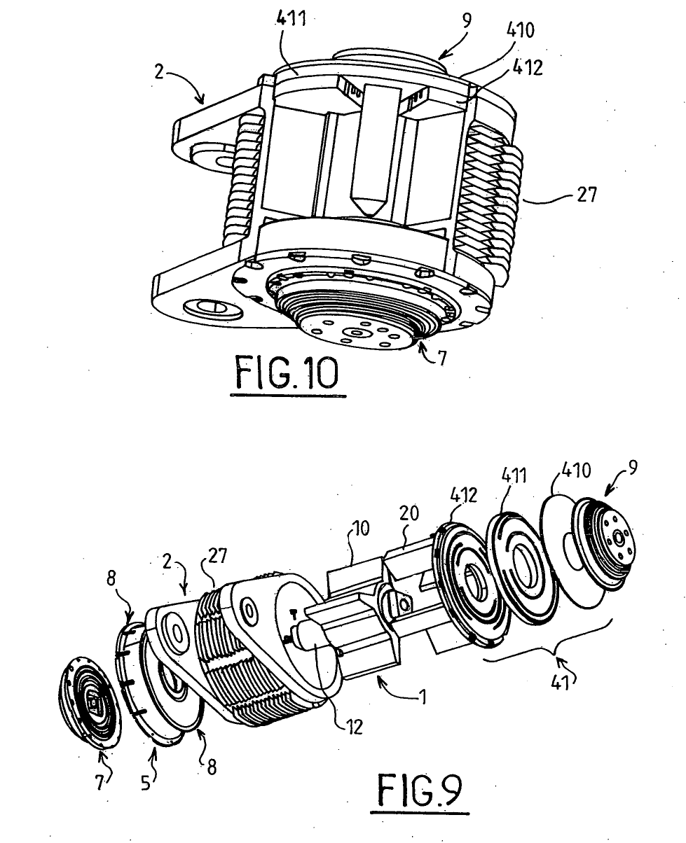

FIG. 10, a perspective view of the damper illustrated in FIG. 9, once assembled,

FIG. 11, which includes FIGS. 11A to 11D showing parts illustrated on FIGS. 9 and 10.

FIG. 12, a upper view of a conduit arranged as a single deck, which is an alternative to the embodiment illustrated in FIGS. 9, 10 and 11B.

In these figures, like references designate like elements.

The rotary damper illustrated in FIGS. 1 through 3 comprises a stator 1 of substantially cylindrical external shape and a rotor 2 of substantially cylindrical internal shape. The stator and the rotor are coaxially mounted on a rotation axis 3 and closed on both sides by respectively a top cover 4 and a bottom cover 5. The top cover is not shown on FIG. 1.

The rotor 2 comprises two symmetrical eccentric parts 28 and 29 with apertures 22, 23 facing each other and equipped with bushings 24, 25. By means of a rod assembled between these bushings, the rotor 2 can be linked to the mobile part of a mechanism (not shown on the figures).

The stator and the rotor could be interchanged depending on the implementation of the rotary damper.

A main chamber 6 is defined between the stator, the rotor and both covers. Therefore, generally speaking, the damper includes a housing with a substantially cylindrical lateral wall, a top and a bottom, inside which the main chamber is defined.

The main chamber is filled with a viscous fluid such as silicone oil but not limited to silicone oil. The viscosity of the oil can vary in a large range to adjust the damping characteristics of the damper.

Some manufacturers, among others, of silicone oil are Baysilone Oils (supplied by Momentive Performance Materials) and Dow Corning Oils.

The use of various damping fluids is not restricted to silicone oil. Silicone oil is a pseudoplastic viscous fluid (i.e. as the shear rate is increased beyond a threshold, the effective viscosity is reduced). Other fluids that can be used are dilatant fluids (i.e. as the shear rate is increased beyond a threshold, the effective viscosity is increased). Such fluids include corn starch-water mixture. Another fluid, amongst many other types, that can be used is a Bingham fluid that, after exceeding a shear stress yield, illustrates a change in shear strain.

Magneto-rheological (MR) fluids can be used with magnetic-field inducing electrical wires located on the interior/exterior of the housing. The magnetic field controls the alignment of the suspended particles of the MR fluids, increasing or decreasing viscosity, thereby allowing control of the damping characteristics of the damper. Control of the damping characteristics is desired for different flight profiles of the helicopter mission, allowing a more refined aerodynamic performance of the helicopter main rotor blades.

As a general rule, a person skilled in the art will choose a suitable damping fluid according to the structure of the damper and the required damping characteristics.

The stator 1 comprises a plurality of radial paddles 10 distributed regularly around rotation axis 3 (four in the illustrated embodiment). These paddles are perforated with orifices 100 to implement relief valves 120, for torque limitation purposes. These orifices 100 are shown in FIGS. 1, 4 and 5 but not in FIGS. 2, 7, 9 and 10.

The pressure relief valves work in one direction. Therefore, the valves are provided by pairs at each location and installed to operate in opposite directions to relief pressures from tandem chambers as the paddles oscillate back and forth.

The implementation of these valves provides a limitation of the torque delivered by the rotary damper by limiting the pressure inside the chambers. The use of relief valves is optional. The design can be such that maximum pressure seen by the damper is lower than the structural load limits of the metal components. The location of these valves is open to several possibilities. Aside from the location on the rotor paddles, the alternative location can be on the stator paddles. The design of these valves (geometry and cracking pressure) conditions the opening pressure threshold.

The rotor 2, when integrated with the top cover 4, also comprises a plurality of radial paddles 20 regularly distributed around axis 3 (four in the illustrated embodiment). This configuration is an alternate, in terms of manufacturability, to the one presented in FIGS. 1 and 7, of which the radial paddles are integral to the rotor 2.

In the illustrated embodiment, the paddles of the rotor and of the stator are respectively disposed at 90° one from the other.

The main chamber 6 is thus divided into a plurality of auxiliary chambers 60 which are filled with fluid (eight chambers in the illustrated embodiment).

The stator 1 presents a central bore 11 in which is mounted a main shaft 12.

One configuration of the embodiment comprises of the main shaft 12 presenting, on its external wall, at least one channel or groove 121a (four channels in the illustrated embodiment), specially shaped in all of its features, namely length, profile, and cross-section, to provide the desired damping characteristics.

Once the shaft 12 and the stator 11 assembled, said channel or groove defines with the facing wall of the stator 1, a conduit or a fluid passage 129a.

The shape of the conduit is not restricted to the letter “Z” (as depicted in FIG. 6A), it can also be W, U, I, L, V, S or any other shapes (examples illustrated on FIGS. 6B, 6C, 11A-11D and 12); damping is determined by the conduit length, profile, and cross-section, fluid viscosity, and the extent of fluid turning while transiting in the conduit. The use of more or less complicated conduit shapes enables to extend the length of the conduit as required by damping characteristics requirements vs. a linear conduit with a shorter length.

Reference is now made to FIG. 6.

FIG. 6A illustrates the conduit 121a shown on FIG. 2. This conduit presents a Z-shape.

FIG. 6B illustrates a conduit 121b having a sinusoidal shape extending perpendicular to the axis of the shaft 12 while the conduit 121c shown on FIG. 6C has a sinusoidal shape extending parallel to the axis of the shaft 12.

Damping in these embodiments of the rotary damper system is achieved through the relative motions between two mechanical sub-systems. One sub-system, for instance the rotor, is grounded (in this case, to the helicopter main rotor hub) while the other sub-system, for instance the stator, is linked to the part in relative motion (in this case, to the helicopter main rotor blade). Between these two sub-systems form the damping chambers, of which the relative motions between rotor and stator expand and contract to a motion spectrum consisting of a particular rotational amplitude and frequency. In one particular motion, one damping chamber of an associated tandem pair of chambers contracts from the resulting motion of one rotor paddle proceeding towards one stator paddle, effecting a reduction in chamber volume. Fluid from the contracting chamber is urged through a linking fluid passage, such as the conduit, towards the expanding chamber.

As fluid flows through the conduit, the average fluid shear rate is determined by the cross-sectional radius (one half of the hydraulic diameter), which is also responsible for the average fluid velocity in the conduit. In some cases, such as for non-newtonian fluids, the average fluid shear rate is an important variable that limits the apparent viscosity of the fluid in the conduit. In a system where silicone oil is used, its pseudoplastic nature translates to a decreasing effective viscosity as the average shear rate is increased beyond a shear threshold. It is clear then for such fluids that the design of the rotary damper should be confined to the limits of the shear threshold for an optimal configuration. To iterate, it may not be beneficial to excessively increase average shear rate in order to increase damping. On the contrary, exceeding shear threshold can be another form of torque limitation advantage, appropriately complementing or substituting relief valves, which are mentioned earlier. These phenomena are absent for ideal Newtonian fluids, since for such fluids, shear stress is proportional to shear rate.

The combination of average shear rate, effective viscosity, conduit length and paddle size then determines the magnitude of pressure loss across the conduit. This is equivalent to the pressure difference between the contracting chamber and the expanding chamber. Paddle size is typically fixed by envelope requirements of the system. Such a pressure difference between tandem chambers then translates to a reaction force applied to the paddles across the surface of their face, leading to, at a system level, an apparent damping reaction torque.

FIG. 4 shows the conduit 121a on the shaft 12. References 122 and 123 designate its opened ends.

The stator 1 presents, between two adjacent paddles 10, two entry holes 124 and 125. These two entries connect to the conduit and provide the path between the fluid chamber working in compression and the associated fluid chamber.

Fluid chambers are working in tandem. The openings 124 and 125 (coincide with opened ends 122 and 123) are the port of entry for the fluid to go from one “chamber” to the “sister or associated chamber” going through the Z-conduit 121a. When a rotation of the rotor occurs, the fluid in one chamber is compressed and therefore is constrained to flow through the conduit and transfer to the associated chamber. Two associated chambers can be consecutive or inconsecutive.

The conduits are not expected to be connected to each other except for filling purposes. Connection between conduits could be implemented.

The size (inner diameter and length) of this conduit and the viscosity of the fluid leads to a certain amount of damping for given operating conditions.

The conduits can be presented in other configurations, such as a location on the external wall of the main damping chamber (i.e. along the internal wall of the damper housing), or on the top/bottom/top and bottom of the main damping chamber. The location of these conduits can be determined by the envelope the damper needs to satisfy. The conduits are opened at both ends with each end presenting an entry or an exit for the conduit.

FIGS. 7 and 8 illustrate another configuration where a conduit is located on the outside diameter of a damper chamber.

FIG. 7 is a view similar to FIG. 2 but it is simplistic.

The stator 1 comprises an external housing 21 and an internal cylindrical part 26. This latter presents the radial rotor paddles 20 which extend radially towards the central axis of the cylindrical part 26.

The structure of the damper illustrated in FIGS. 7 and 8 is essentially the same as the one of the damper illustrated in FIGS. 1 to 5, except that in FIGS. 7, 8, 9 the rotor paddles and the main shaft 12 are integrated (single piece) since the conduits are not present on the main shaft.

Accordingly, in the damper illustrated in FIGS. 1 to 5, the stator includes only one part, since no conduits are provided on the outside diameter of the damper chamber.

On the outer wall 260 of the cylindrical part 26, is provided a channel 261. In this example, it includes several parallel parts which extend at least along a portion of a circumference of the outer wall.

Considering FIG. 8, a conduit or a fluid passage 269 is thus provided along the internal wall 210 of the damper housing 21.

FIGS. 9 and 10 illustrate another configuration where a conduit is located on the top cover 41 of the damper device.

The top cover 41 includes three parts 410, 411 and 412.

Reference 410 represents the cover to seal the conduits on the top. A cut-away version is shown in FIG. 11C and partially in FIG. 11D.

Reference 411 represents the upper “deck” of conduits. A cut-away version is shown in FIGS. 11B and 11C.

Reference 412 represents the lower “deck” of conduits. A cut-away version is shown in FIG. 11A and in FIG. 11B. It can be integrated with the top cover (which has the rotor paddles) and contains conduit entries and exits into and out of the damping chamber. Both the upper deck 411 and the lower deck 412 are in such a configuration (double deck) to increase the length of the conduits.

FIGS. 11A to 11D show cut-away views to illustrate cross-section of elements illustrated in FIG. 9.

FIG. 11A shows lower deck 412 which includes entry or exit to conduits.

FIG. 11B shows upper deck 411 on top of lower deck 412. The double-deck serves as extension of conduits.

FIG. 11C shows complete assemblies of the cover 410, the upper deck 411 and the lower deck 412 with cut-aways.

FIG. 11D is another view from the bottom with lower deck 412 and upper deck 411 being translucent.

Certainly this design should not be restricted to two decks. The number of decks depends on damping requirements, which dictates conduit lengths, and envelope.

FIG. 12 illustrates a different conduit solution versus FIGS. 11A-11D which is a single deck configuration.

As shown on FIGS. 3 and 5, the main shaft 12 protrudes from respectively the top cover 4 and the bottom cover 5 when it is mounted in the stator 1. On each of these projecting parts 126, 127 is mounted a conical bearing 7, 9.

The conical bearing 9 is centered in the main shaft 12 and preloaded by means of a bolt 91. It is inserted in a central through opening 92 of the conical bearing 9 and in a corresponding central opening 128 of the main shaft 12 which passes through the projecting part 127. The conical bearing 9 is fixed on the top cover 4 by means of bolts 90b, and the top cover 4 is fixed to the rotor 2 by means of bolts 90a.

Similarly, the conical bearing 7 is centered in the main shaft 12 and preloaded by means of a bolt 71. It is inserted in the central through opening 72 of the conical bearing 7 and in a corresponding central opening 130 of the shaft 12 which passes through the projecting part 126.

The conical bearing 7 is fixed to the bottom cover 5 by means of bolts 70b, while the bottom cover 5 is fixed to the rotor 2 by means of bolts 70a.

Each conical bearing 9, 7 comprises a rigid external housing 93, 73 having an internal conical surface 94, 74, a rigid internal or central housing (or core) 95, 75 having an external conical surface 96, 76, and a resilient body 97, 77 between said internal and external conical surfaces respectively 94, 96 and 74, 76.

The housings 93, 95, 73 and 75 are typically made of metal, while the resilient bodies 97, 77 are a laminated composite, constituted by a succession of conical layers of metal, e.g. steel, and rubber, i.e. multiple layers of elastomers with metallic shims in between every layer.

The core of the conical bearing is mounted onto the shaft by means of a “key” for the purpose of torque transmission. Such a “key” could possibly be presented as a curvic-spline coupling in which the shaft 12 represents the male component of the “key” (corresponding to the projecting parts 127, 126), and a shape-matching cavity on the core 95, 75 represents the female component of the “key”, amongst many other configurations, such as square, hexagonal, or n-polygon shaped keys where n is sufficient enough to transmit contact loads without introducing excessively high stress concentration on the metal. Such a feature is necessary to enable efficient torque transmission between the stator paddles (which have to be fixed to the helicopter blade through the core of the conical elastomeric bearing), where it experiences pressure changes from the working of the viscous fluid, and the core of the conical bearing, which is mounted to the helicopter blade root.

In the embodiment illustrated in FIGS. 2, 3 and 4, the conical bearings 9 and 7 are said “convergent” or “conically converging”, since the layers of the resilient bodies 97, 77 converge towards the interior of the damper.

The invention is not limited to this embodiment and the conical bearings 9 and 7 could also be “divergent” or “conically diverging”, i.e. with the layers of the resilient bodies converging towards the exterior of the damper.

The conical bearings 9, 7 provide a rotational degree of freedom to the top cover 4, respectively to the bottom cover 5 with respect to the core of the bearings. They also ensure the static and dynamic sealing of the damper and withstand the fluid operating pressure.

Such bearings therefore allow relative motion of the rotor 2 and of the stator 1 while avoiding the use of a more traditional form of dynamic sealing, such as O-rings, where such sealing application encounters friction at the O-ring-sliding surface interface, typically resulting in a shorter operational life.

Conical bearings can provide both dynamic sealing as well as possibly guiding of the shaft. In some cases, additional bearings are provided for guiding the shaft. The illustrated embodiments therefore show sleeve bearings.

As shown on FIGS. 3 and 5, a first sleeve bearing 40 is provided between the top cover 4 and the stator 1, a second sleeve bearing 50 is provided between the bottom cover 5 and the stator 1 and a third sleeve bearing 13 is provided between the rotor 2 and the stator 1.

These three bearings are typically self-lubricated bearings.

That is one of the keys to the longevity of the part. On the other hand, if space is available, metal bearings (ball, roller, tapered or needle bearings) can be implemented as well.

An elastomeric bearing can also be used as an alternative to a sleeve bearing.

They contribute to the elimination of any cocking motion between the stator and the rotor.

It is understood that the main chamber, the conduits and the auxiliary chambers are filled with the same damping fluid.

Reference 8 designates a volume compensation device. Its purpose is to accommodate the fluid volume change due to temperature variations. Referring to FIGS. 2 and 3, this device 8 is housed in a cavity 80 defined by a transverse wall 200 of the rotor 2 and the bottom cover 5.

It comprises a piston 81, a plurality of springs 82 being mounted between the piston and the bottom cover. These springs are substantially parallel to the axis 3. A diaphragm 83 is provided on the piston.

An auxiliary chamber 84 is defined between the wall 200 and the diaphragm 83 and it communicates with the main chamber 6 through small communication holes in wall 200. The diaphragm provides suitable sealing of the auxiliary chamber 84, so that no liquid from the main or auxiliary chambers may reach the part of the cavity 80 which houses the device 8.

Moreover, a plug 85 is provided in the rotor to close the chamber 84.

In nominal operating conditions of the damper, the piston is urged towards the wall 200.

When the volume of the fluid increases appreciably, it passes from the main chamber into the auxiliary chamber through said orifices, moving the piston of a sufficient quantity to compensate for the variation in the volume of the fluid. When the fluid temperature goes down, this resulting in a reduction of the volume, the piston delivers the fluid from the auxiliary chamber towards the main chamber under the action of the springs.

Therefore, it is possible with the device 8 to compensate for the variations in volume of the viscous fluid as a function of its operating temperature.

The location of the volume compensation device is not limited to the one illustrated in FIGS. 2, 3, 7 to 10, i.e. beneath the rotor and stator. It can also be located above the rotor and stator, or radially on the housing if envelope is restricted at the ends of the rotary damper.

As shown on FIGS. 9 and 10, cooling fins 27 for heat-sink function (energy dissipative) can be provided on the exterior of the housing of the rotor 2 since as the damper is worked, viscous shearing of the fluid produces energy which generates heat and increases the temperature of the damper. Increase in such temperature degrades reversibly the fluid performance through reduction in fluid viscosity, which subsequently results in loss of damping.

The location of these cooling fins are not restricted to the outside cylindrical wall of the housing. They can be located on the top and bottom as well, depending on envelope requirements.

A heating element can be provided on the interior and/or exterior of the damper housing to provide elevated fluid temperatures prior to helicopter warm-up start in low temperature environments. This feature will reduce the amount of damping since viscosity increases at a logarithmic rate as temperature decreases. The heating element can be self-powered by a high-density battery system, such as miniature fuel cells, or Li-ion batteries, whose current flow-through is controlled by a thermocouple.

Moreover, according to the invention, an anti-wear coating is provided on the dynamic surfaces that are in proximity with static surfaces or that may come into contact with static surfaces. Coating minimizes wear and therefore maintains the gap tolerances of abrading surfaces. Gap sizes correlate to damping losses from cross-chamber fluid flow results in higher fluid transfer between chambers and lower shear rate through the conduits.

In order to make the damper completely leak-tight, several static sealing joints are provided, typically O-rings, with reference numerals 110, 111, 112, 113 or 114.

Autonomous pressure monitoring systems can be used to allow damper diagnosis for operators out in the field, allowing the monitoring of damper performance history at the time maintenance, throughout the life of the part.

Such system can comprise of two pressure transducers, one for monitoring each of any tandem damping chambers, and a miniature data-logger that can be powered by a high density battery, such as a Li-ion battery or fuel cell, dependant upon battery life and envelope requirements.

1) A rotary viscous damper comprising a stator and a rotor defining between them a main chamber filled with a fluid, substantially radial paddles being disposed on each of said stator and rotor, said paddles dividing said main chamber into a plurality of chambers, and presenting means to create a fluid communication between the chambers, said damper further comprising at least one conical elastomeric bearing between the stator and the rotor.

2) A damper as claimed in claim 1, wherein is further provided another bearing between the stator and the rotor, for improving the guidance between the stator versus the rotor.

3) A damper as claimed in claim 1, wherein the said at least one conical elastomeric bearing comprises a metal-elastomer laminated material.

4) A damper as claimed in claim 3, wherein said metal-elastomer laminated material consists of multiple layers of elastomers with metallic shims in between every layer.

5) A damper as claimed in claim 4, wherein the said layers are conically converging to the center of the damper.

6) A damper as claimed in claim 4, wherein the said layers are conically diverging to the center of the damper.

7) A damper as claimed in claim 1, wherein it further comprises a volume compensation device.

8) A damper as claimed in claim 7, wherein the volume compensation device comprises an auxiliary chamber which communicates with said main chamber, said auxiliary chamber being defined between a substantially transverse wall of the rotor and a sealing diaphragm, which is elastically urged against the said wall.

9) A damper as claimed in claim 8, wherein the diaphragm is provided on a piston which is loaded by springs, in order to be axially movable in function of the temperature of the fluid in the main chamber.

10) A damper as claimed in claim 1, wherein at least one conduit is provided, with opened ends in fluid communication with entry holes of the stator, to create a fluid communication between two associated chambers.

11) A damper as claimed in claim 10, wherein the rotor presents a central bore in which is mounted a shaft, the said at least one conduit being provided on the external wall of said shaft.

12) A damper as claimed in claim 10, wherein the said at least one conduit is provided on the external wall of the main chamber.

13) A damper as claimed in claim 10, wherein it comprises the said at least one conduit is provided on the top, on the bottom or on top and bottom of the main chamber.

14) A damper as claimed in claim 10, wherein the length, cross-section and profile of said at least one conduit are determined to provide the required damping characteristics.

15) A damper as claimed in claim 1, wherein it includes relief valves for torque limitation purposes.

16) A damper as claimed in claim 15, wherein the relief valves are provided by pairs at each of their location.

17) A damper as claimed in claim 1, wherein an anti-wear coating is provided on dynamic surfaces subject to abrasion.

18) A damper as claimed in claim 1, wherein an autonomous pressure monitoring system is provided to make maintenance easier.

19) A damper as claimed in claim 1, wherein cooling fins are provided on the exterior of its housing.

20) A damper as claimed in claim 1, wherein a heating element is provided inside or outside its housing.
